(19) United States
(12) Patent Application Publication
(10) Pub. No.: US 2006/0242136 A1
(43) Pub. Date: Oct. 26, 2006

(54) Parameterized command protection

(75) Inventors: Bradley M. Hammond, Bellevue, WA (US); Janaina B. Bueno, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/112,414

(22) Filed: Apr. 22, 2005

(51) Int. Cl. G06F 17/30

(52) U.S. Cl. 707/4

(57) ABSTRACT

In a database system utilizing parameterized commands, proposed parameter values are processed prior to execution of such parameterized commands to reduce the likelihood that such commands will inject additional, unanticipated database commands. Specifically, the parameter value is modified in certain ways that reduce its likelihood of injecting additional database commands. In addition, if the proposed value is found to have certain characteristics, the parameterized command is not executed.

### TECHNICAL FIELD

The techniques described below relate to protecting databases from unintended intrusions and attacks that might otherwise result from the use of parameterized queries.

### BACKGROUND

Substantial efforts have been made in recent years to combat malicious attacks against various types of data repositories. Many such repositories are now publicly accessible through the Internet, and have therefore become much more visible as potential targets.

Attacks against websites and data repositories can take many forms. In some cases, the attacks are merely pranks, designed to temporarily disable a website or otherwise demonstrate a successful attack in a manner that does not cause significant long-term damage. In other cases, however, successful attacks can result in immediate, lasting harm and financial loss. For example, an attack might result in private data being stolen or made public, or in the corruption or entire loss of business-critical data.

Attacks can be carried out in many ways, including through manual user interaction and automated programming. Databases, in particular, are often programmed to accept requests and other commands either by way of manually entered statements or by way of programming interfaces. Such requests can sometimes be used in attacking databases.

When used alone, database engines often provide nearly unrestricted access to data and to commands that might affect the data. Although this provides a great deal of power and flexibility, it also leaves the database vulnerable to mistakes and malicious activities that might damage the database or its data. Furthermore, the command languages used by most databases are complex and difficult for average users to master.

In order to protect data and provide a more friendly user experience, most database applications utilize both a database engine and some kind of user interface or shell that is tailored to the particular types of data access and entry required by the particular data application. Rather then using a command line interface, as do many database engines, such a user interface typically uses a graphical display in which data is arranged conveniently and intuitively. Simple menus, labels and prompts are used to instruct the user where and how to enter or modify data. Data access is generally limited by the functions and programming of the user interface, so that the user is prevented from performing any functions other than those provided by the user interface. As an extreme example, some user interfaces might allow only for viewing of data, and provide no way for a user to actually modify such data.

Similar shell-type interfaces are also used to insulate a database and its database engine from other programs that might need to access database data. For example, a database might be implemented by a database engine and a supervisory program or shell. In this situation, other programs submit database requests through the supervisory program rather than directly to the database engine itself. The supervisory program has interfaces tailored for the specific types of access likely to be needed by outside programs. Because data access is only permitted through these interfaces, only the specific types of activities provided for by the interfaces are possible. If implemented correctly, this reduces the likelihood of mistakes and malicious attacks on the database.

Even with shell-type interfaces as described above, however, it is frequently difficult to anticipate every permutation of data that might be required by a user or outside program. Because of this, databases and database interfaces often use so-called “parameterized” queries, where the query contains “blanks” or variables that are to be filled in at execution time with data supplied by a user or other outside source (such as another program). The query itself is usually limited in some way, such as by being a read-only query or being directed to only a particular table. Furthermore, the parameter to be supplied by an outside source is used only in conjunction with other limiting syntax in ways that allow data access or modification only in predefined ways. For example, the query might request all records of a table in which a certain column has values that match the supplied parameter:
SELECT * FROM contacts WHERE initials=‘&param&’
where ‘&param&’ is a string parameter or variable, the value of which is to be supplied by an outside source at runtime. For example, a user might supply the value BLH, and at runtime the query would be executed in the form:
SELECT * FROM contacts WHERE initials=‘BLH’
Note that the example above and those that follow are formatted in accordance with the SQL database programming language. Other database languages can also be used.

On its face, the “SELECT” query shown above is not possible of doing anything except listing data from a selected table. Assuming this is what is intended, seemingly no harm can come from the query, regardless of what value the user supplies.

However, the inventors have found it necessary to deal with certain situations in which malicious attacks might indeed be accomplished by way of parameterized queries as described above. Methods for doing this are described below.

### SUMMARY

Before executing a parameterized command, the proposed parameter value is processed to reduce its likelihood of injecting additional database commands. In addition, if the proposed value is found to have certain characteristics, the parameterized command is not executed.

### BRIEF DESCRIPTION OF THE DRAWINGS

FIG. 1 is a block diagram of a database system in which the described techniques can be implemented.

FIG. 2 is a flowchart illustrating the described techniques.

### DETAILED DESCRIPTION

As described above, a parameterized database command is a predefined database statement that is completed dynamically, at or before runtime. In the SQL database programming language, this can be illustrated by queries or other commands in which a parameter is represented by a variable, where the value of the variable will be supplied at runtime. The examples below use a syntax in which a name is surrounded by ampersand characters to indicate a variable: &variable&.

Consider the following parameterized query:
SELECT * FROM contacts WHERE initials=‘&param&’

Now suppose that a user or some program component supplies the following value for ‘&param&:
BLH′ UPDATE contacts SET permission=TRUE WHERE initials=‘BLH
When the query is executed, the SQL interpreter inserts the supplied text string directly in place of &param&. The resulting query is as follows:
SELECT * FROM contacts WHERE initials=‘BLH’
UPDATE contacts SET permission=TRUE WHERE initials=‘BLH’

Thus, by manipulating the supplied parameter, the user is able to surreptitiously inject an additional SQL command into the otherwise harmless SELECT command. In this example, the additional SQL command is an UPDATE command, which could be used for a variety of purposes to alter database data in harmful ways. Many other harmful commands could also be injected, such as various executive-level commands, DELETE commands, and others.

The techniques described below reduce the likelihood that such SQL injection attempts will be successful.

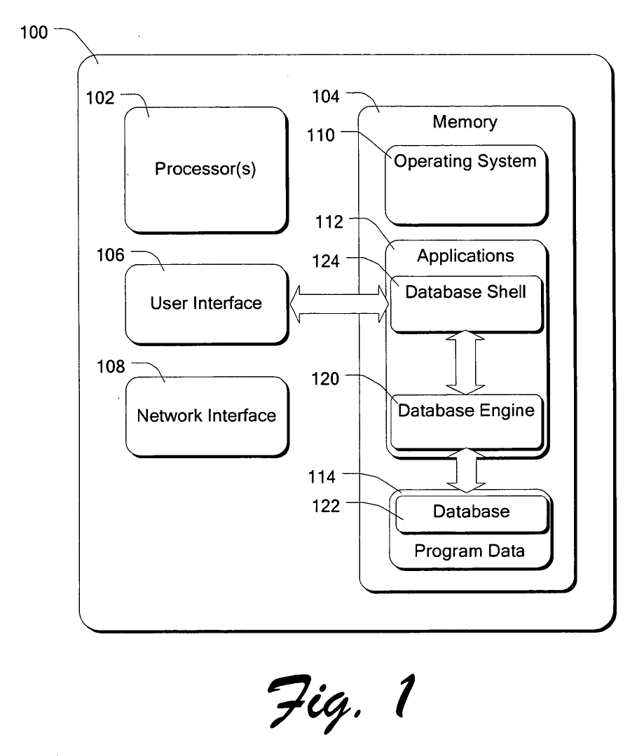

FIG. 1 shows an example of a client/server database system in which the described techniques might be utilized. The system comprises a computer that includes one or more processors 102 and memory 104. Memory 104 may comprise various different types of computer readable storage media, including volatile and non-volatile memory, removable and non-removable memory, electronic and magnetic-based media, and media utilizing various other types of storage technology.

Memory 104 contains programs and/or instructions that are executable by processor(s) 102 to perform the functionality described below. Such programs and instructions are stored at different times in the different forms of available memory of the system. Programs are typically distributed, for example, on floppy disks or CD-ROMs. From there, they are installed or loaded into the secondary memory of a computer. At execution, they are loaded at least partially into the computer's primary electronic memory. The invention described herein includes these various types of computer-readable storage media when such media contain instructions or programs for implementing the described operations and functions in conjunction with a microprocessor or other data processor. The invention also includes the system or computer itself when programmed according to the methods and techniques described below.

Computer system 100 also includes a physical user interface 106, which typically comprises a graphical display, a keyboard, and a mouse. Other types of user interfaces can also be used.

Computer system 100 also includes an optional network interface 108, which might comprise an Ethernet interface, a telephone modem, a wireless network interface, or some other type of interface. This interface is used to connect computer system 100 to a network, which might be a private network, a local-area network, a wide-area network, and/or a public network such as the Internet.

As further shown in FIG. 1, system 100 includes an operating system 110, one or more application programs 112, and program data 114. For purposes of illustration, programs, program components, and data are shown in FIG. 1 as discrete blocks within memory 104, although it is recognized that such functionality can be allocated in many different ways between computer components.

One of application programs 112 is a database server program 120 such as SQL Server, available from Microsoft Corporation. Microsoft SQL Server is a relational database engine that is programmed and maintained using a version of the SQL database programming language.

Within program data 114 is an actual database 122, comprising data maintained by database engine 120. Database 122 comprises tables, views, stored procedures, and other components used and executed by database engine 120 to define both the data and the functionality of database 122.

Many database applications will also include a shell program or interface 124. This is often a client-based program, sometimes referred to as a database “front-end,” that interacts with a user through user interface 106 to transfer information to and the user. Although shown as being implemented within the same computer as database engine 120, multiple instances of the database shell might execute remotely on different client computers (not shown), which would communicate with database engine 120 through network interface 108.

Database shell 124 can be implemented using many different technologies, including various different types of programming languages. As an example, many spreadsheet programs can be configured to function as a front-end to a database. Typically, shell programs such as this interact with database engine by way of SQL commands and responses. SQL commands are formulated by the database shell and submitted to the database engine. In response, the database engine reports data to the shell and, depending on the nature of the SQL commands, alters or adds data within database 122.

As described above, so-called “parameterized” queries or commands are sometimes used in database systems such as this. For example, database engine 120 might have stored procedures that accept parameters from shell program 124 for inclusion in variable portions of predefined SQL statements that are otherwise predefined by and within the stored procedures.

Alternatively, database shell 124 itself might implement parameterized queries, with values for statement variables to be supplied manually to the database shell by a user or by some other calling program or procedure. In this situation, the database shell substitutes the supplied values at specified locations within predefined database commands.

In general, parameterized SQL commands can be implemented in many different functional components of database systems. A parameterized command comprises a predefined command, query, or statement having one or more variables whose values are not initially part of the command definition. Prior to executing the command, an actual value is substituted for the variable. The value is typically obtained from some other program component or a user, and is potentially different each time the command is executed. As discussed above, however, allowing untrusted programs or users to supply such variable values can expose a system to unwanted intrusions or attacks.

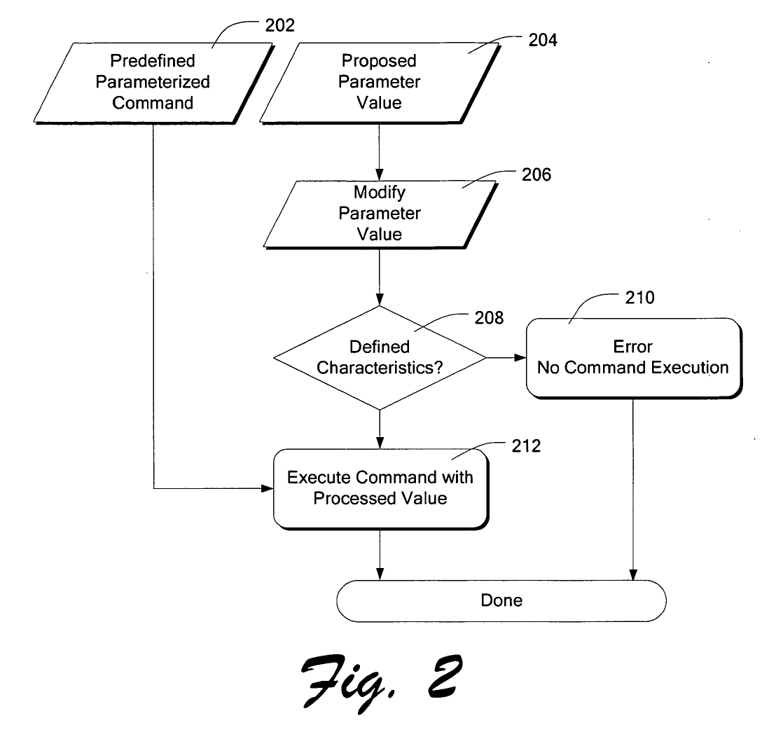

FIG. 2 shows methods implemented within computer 100 to help safeguard against such intrusions or attacks. These methods can be implemented wherever parameterized queries are utilized: within stored procedures of database engine 120, within database shell 124, or within other components that combine externally supplied values with predefined database commands, statements, or queries.

Block 202 represents a predefined parameterized command used within a database component. The parameterized command has at least one variable portion for which a value will be supplied prior to execution of the command. Below are some examples of parameterized commands, where the variable portion of each statement is represented by “&param&”:

SELECT * FROM contacts WHERE &param&=‘BLH’

SELECT * FROM contacts WHERE &param&

SELECT * FROM contacts &param&

SELECT * FROM contacts WHERE initials=‘BLH’ &param&

SELECT * FROM contacts WHERE initials=‘BLH’ ORDER BY &param&

There are of course many other possibilities.

Block 204 represents a proposed parameter value for use in the variable portion of predefined database command 202. The parameter value is typically a text string intended to be placed within predefined parameterized command 202. The exact format and syntax of the text string will depend upon the nature of the predefined command with which it is intended to be used. Below are some examples of the types of text strings that might form parameter values:

The name of a column, such as “initials”

A criteria clause, such as “initials=‘BLH’”

A criteria value, such as “BLH”

A WHERE clause, such as “WHERE initials=‘BLH’”

An ORDER BY clause, such as “ORDER BY date”

An ORDER BY column, such as “date”

A WHERE clause and appended ORDER BY clause

Many other examples could of course be given.

Blocks 206 and 208 comprise, prior to executing the predefined database command with the text string in its variable portion, receiving, analyzing, and processing the text string to reduce its likelihood of injecting an additional database command into the predefined database command. Such processing involves determining whether the string has certain characteristics that make it more likely to inject an additional command, and/or modifying the string to eliminate some characteristics that might make the string more likely to inject a command.

Specifically, block 206 comprises modifying proposed parameter value 204, depending on the nature of predefined parameterized command 202, in ways designed to make it less likely that a supplied parameter value can be used for SQL command injection.

There are at least two ways in which block 206 modifies parameter value 204, summarized as follows:

Add surrounding parentheses around WHERE arguments or criteria

Truncate ORDER BY clauses

First, in any situation where parameter value 204 is intended to be or include a criteria argument for a WHERE clause, the criteria argument is surrounded by parentheses before subsequent processing steps. This simplifies subsequent processing.

There are at least three variations of this situation. One variation is where parameter value 204 is intended to be a WHERE clause, which includes both the WHERE keyword and the subsequent criteria clause. In this situation, the part of parameter value 204 that follows the “WHERE” keyword is surrounded by parentheses.

Another variation is where parameter value 204 is intended to be a WHERE criteria clause, without the WHERE keyword. In this situation, the entire parameter value 204 is surrounded by parentheses.

Yet another variation is where parameter value 204 is intended to be a WHERE clause that includes an ORDER BY clause. In this situation, the part of parameter value 204 between the WHERE keyword and the ORDER BY keywords is modified by adding surrounding parentheses.

Second, where parameter value 204 is intended to be an ORDER BY clause, block 206 truncates any part of value 204 that is not validly part of the ORDER BY clause. More specifically, the only words allowed after the ORDER BY keywords are a single name and an optional directional keyword (ASC, ASCENDING, DESC, or DESCENDING) that follows immediately after the single name. Value 204 is truncated either after the single name, or after the immediately following directional keyword if one is supplied. This same action is taken where parameter value 204 is intended to be a WHERE clause that includes an ORDER BY clause: value 204 is truncated after a single name following the ORDER BY keyword, or after the immediately following directional keyword if one is supplied.

Block 208 operates on parameter value 204 as potentially modified by block 206. Block 208 comprises determining whether the parameter value 204 has certain characteristics that make it more likely to inject an additional SQL command into the original predefined parameterized SQL command. If the proposed value does have such characteristics, execution flows to block 210, which comprises raising an error flag and not executing the predefined parameterized command. Only if the proposed value does not have such characteristics, execution flows to block 212, which comprises executing the predefined parameterized command, substituting parameter value 204 (as potentially modified by block 206) for the variable portion of the command.

There are currently several characteristics that are detected in block 208. First, block 208 determines whether there are any embedded comments in proposed text string 204. In the SQL language, the start of a comment is indicating by two adjacent leading dashes, such as “--”, or by a forward slash and immediately following asterisk, such as “/*”—unless these character combinations occur within a string literal, in which case they are simply part of the string literal. Accordingly, block 208 checks for either of these character combinations occurring outside of a string literal, and returns a positive result if either is found. Thus, predefined command 202 is executed in block 212 only if the proposed parameter value does not have any characters indicating comment text.

Not permitting comments within parameter values simplifies subsequent processing. Comments are not needed in this environment, and if they were allowed, subsequent processing procedures would have to keep track of them and account for them in checking and modifying the proposed text strings. It is much simpler to disallow them.

Block 208 also checks for embedded string delimiters in some situations. In particular, where value 204 is intended to be used as a string literal within command 202, block 208 checks for any embedded string delimiters (single quotes in SQL) and returns a positive result if any are found. Thus, predefined command 202 is only executed if the proposed parameter value does not have any embedded string delimiters. An exception is made in the case where a single quote is used as an escape character for a single quote that is to be part of the string literal. In SQL, this is a pair of single quotes: ‘ ’. A pair of single quotes is allowed since it is converted to a single quote within the string literal. In other words, only single quotes that actually function as string delimiters are disallowed. Single quotes that function as escape characters are allowed.

The reason for not permitting embedded string delimiters in situations such as this is that they can be used to inject additional SQL commands, as already described above. Disallowing embedded string delimiters prevents such injection.

Block 208 also checks for mismatched parentheses in some situations. In particular, where the text string 204 is intended to be used as an argument within command 202, in which it will be surrounded by parentheses, block 206 checks for any mismatched parentheses within text string 204. Matching embedded parentheses are allowed. However, parentheses must occur in matching and properly ordered opening and closing parentheses.

Checking for mismatched parentheses prevents SQL injection in conjunction with a parameterized query such as the following:
SELECT * FROM contacts WHERE (&criteria&)
where the parameter value is intended to be a string that defines a search criteria. Without checking for mismatched parentheses, a parameter value such as the following might be supplied:
1=1) UPDATE contacts SET Permission=TRUE WHERE (initials=‘BLH’
When substituted for &criteria&, this would result in
SELECT * FROM contacts WHERE (1=1)
UPDATE contacts SET Permission=TRUE WHERE (initials=‘BLH’)
However, because the proposed parameter value has mismatched parentheses (a closing parenthesis with no preceding and corresponding opening parenthesis), this parameter value is not allowed and the injection attempt fails. In this situation, parentheses are considered to be matched or balanced only if all parentheses occur in exclusive pairs in which the first of each pair is an opening parenthesis and the last of each pair is a closing parenthesis. Nested parentheses are therefore allowed.

In actual implementation, all parameter values intended to be used as WHERE clauses are wrapped by an added opening and closing parentheses as part of block 206. Because of this, determining whether parentheses of a parameter value are matched can be performed by checking that there are no additional characters after the closing parenthesis that matches or corresponds to the added opening parenthesis.

If in block 206 it is determined that proposed parameter value 204 does not have the characteristics described above that make SQL command injection more likely, block 212 is executed. Block 212 comprises executing the predefined parameterized command 202, substituting parameter value 204 (as potentially modified by block 206) for the variable portion of the command. In situations where value 204 is expected to be a string literal, string delimiters are added around value 204 prior to substitution in command 202.

The techniques above eliminate several vulnerabilities that would be otherwise present when using parameterized commands whose parameters are to be supplied by potentially untrusted entities. Furthermore, the techniques can be implemented with very little processing overhead, and with little or no loss of flexibility with regard to legitimate and normal uses of parameterized commands.

It should be noted that the particular SQL examples given above demonstrate only one way of implementing parameterized commands, and that other programming mechanisms and methodologies can also be used to accomplish the same results. For example,

The invention has been described in language more or less specific as to structural and methodological features. It is to be understood, however, that the invention is not limited to the specific features described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A method of processing dynamically-created database commands, comprising:
receiving a parameter value for use in a variable portion of a predefined database command; and
prior to executing the predefined database command with the parameter value in the variable portion, processing the parameter value to reduce its likelihood of injecting an additional database command into the predefined database command.

2. A method as recited in claim 1, wherein the parameter value is expected to be a string literal, said processing comprising determining whether any string delimiters occur within the parameter value, the method further comprising executing the predefined database command with the parameter value in the variable portion only if no string delimiters occur in the parameter value.

3. A method as recited in claim 1, said processing comprising determining whether the parameter value contains any characters indicating comment text, the method further comprising executing the predefined database command with the parameter value in the variable portion only the parameter value does not contain any characters indicating comment text.

4. A method as recited in claim 1, said processing comprising:
determining whether the parameter value contains any mismatched parentheses.

5. A method as recited in claim 1, said processing comprising:
adding first and second surrounding parentheses to the parameter value; and
determining whether the parameter value contains any text following a closing parentheses that corresponds to the first added surrounding parenthesis.

6. A method as recited in claim 1, said processing comprising:
modifying the parameter value to reduce its likelihood of injecting an additional database command into the predefined database command and executing the predefined database command with the modified parameter value in the variable portion.

7. A method as recited in claim 6, said modifying comprising enclosing at least a portion of the parameter value in parentheses.

8. A method as recited in claim 6, wherein the parameter value is expected to include at least part of ORDER BY clause, said modifying comprising truncating any part of the parameter value that is not validly part of the ORDER BY clause.

9. A method as recited in claim 6, wherein the parameter value includes an ORDER BY argument, wherein said modifying comprises truncating any part of the parameter value that is not validly part of the ORDER BY argument.

10. One or more computer-readable media containing instructions for processing dynamically-created database commands, the instructions being executable by a computer to perform actions comprising:
receiving a text string for use in a variable portion of a predefined database command;
executing the predefined database command with the text string in the variable portion only if none of the following conditions are met:
the text string is expected to be a string literal and contains one or more string delimiters;
the text string contains one or more characters indicating comment text;
the text string is expected to be at least part of a WHERE clause and has mismatched parentheses.

11. One or more computer-readable media as recited in claim 10, the actions further comprising:
modifying the parameter value to reduce its likelihood of injecting an additional database command into the predefined database command and executing the predefined database command with the modified parameter value in the variable portion.

12. One or more computer-readable media as recited in claim 11, said modifying comprising enclosing at least a portion of the parameter value in parentheses.

13. One or more computer-readable media as recited in claim 11, wherein the parameter value is expected to include at least part of ORDER BY clause, said modifying comprising truncating any part of the parameter value that is not validly part of the ORDER BY clause.

14. One or more computer-readable media as recited in claim 11, wherein the parameter value includes an ORDER BY argument, wherein said modifying comprises truncating any part of the parameter value that is not validly part of the ORDER BY argument.

15. One or more computer-readable media containing instructions for processing dynamically-created database commands, the instructions being executable by a computer to perform actions comprising:
receiving a text string for use in a variable portion of a predefined database command;
modifying the text string to reduce its likelihood of injecting an additional database command into the predefined database command; and
executing the predefined database command with the modified text string in the variable portion.

16. One or more computer-readable media as recited in claim 15, wherein the text string is expected to include an ORDER BY clause, wherein said modifying comprises truncating any part of the text string that is not validly part of the ORDER BY clause.

17. One or more computer-readable media as recited in claim 15, wherein the text string includes an ORDER BY argument, wherein said modifying comprises truncating any part of the text string that is not validly part of the ORDER BY clause.
